(19) United States
(12) Patent Application Publication
(10) Pub. No.: US 2008/0061705 A1
(43) Pub. Date: Mar. 13, 2008

(54) CCFL INVERTER WITH SINGLE TRANSISTOR

(75) Inventors: Shwang-Shi Bai, Tainan County (TW); Hsiu-Na Hsieh, Tainan County (TW); Shu-Ming Chang, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: HIMAX TECHNOLOGIES LIMITED, Tainan County (TW)

(21) Appl. No.: 11/850,336

(22) Filed: Sep. 5, 2007

Related U.S. Application Data
(60) Provisional application No. 60/825,447, filed on Sep. 13, 2006.

(51) Int. Cl. H05B 41/36

(52) U.S. Cl. 315/219

(57) ABSTRACT

A power supply circuit for transforming a direct-current voltage into an alternating-current voltage for a light source is provided. The power supply circuit includes a drive circuit, a switch, a transformer and a capacitor. The switch has a control terminal coupled to the drive circuit and a ground terminal coupled to a ground. The transformer has a primary side and a secondary side, and a winding on the primary side is coupled between the direct-current voltage and a signal terminal of the switch to generate the alternating-current voltage on the secondary side. The capacitor is coupled between the ground terminal and the signal terminal of the switch.

### BACKGROUND

1. Field of Invention

The present invention relates to a power supply circuit for transforming a direct-current voltage into an alternating-current voltage. More particularly, the present invention relates to a power supply circuit of a cold cathode fluorescent lamp (CCFL).

2. Description of Related Art

Typically, there are two types of liquid crystal displays for common use. One is reflective type, and the other is transmissive type. In a transmissive-type liquid crystal display, a backlight source is necessary. The transmissive-type liquid crystal display typically uses as the backlight source a cold cathode fluorescent lamp (CCFL) which has the advantages such as high fluorescence efficiency, long lifetime, etc. However, the power supply circuit of the CCFL usually includes two or more transistors, so the power supply circuit is often complex and difficult to produce, such that the production cost and production time cannot be lowered.

For the foregoing reasons, there is a need for a simple power supply circuit to reduce the production cost and time.

### SUMMARY

In accordance with one embodiment of the present invention, a power supply circuit for transforming a direct-current voltage into an alternating-current voltage for a light source is provided. The power supply circuit includes a drive circuit, a switch, a transformer and a capacitor. The switch has a control terminal coupled to the drive circuit and a ground terminal coupled to a ground. The transformer has a primary side and a secondary side. A winding on the primary side is coupled between the direct-current voltage and a signal terminal of the switch so that the alternating-current voltage is generated on the secondary side. The capacitor is coupled between the ground terminal and the signal terminal of the switch.

For the foregoing embodiment of the present invention, the power supply circuit is simpler than many known power supply circuits, so the production cost and production time can be reduced. In addition, the power supply circuit is much easier to be controlled than usual, so it is also convenient to use the power supply circuit for the cold cathode fluorescent lamp (CCFL).

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the preferred embodiment, with reference made to the accompanying drawings as follows:

FIG. 1 shows a power supply circuit of a cold cathode fluorescent lamp (CCFL) according to one embodiment of the present invention;

FIG. 2 shows the operation of the power supply circuit shown in FIG. 1 when the switch is turned on;

FIG. 3 shows the operation of the power supply circuit shown in FIG. 1 when the switch is turned off; and

FIG. 4A and FIG. 4B show the voltages on the primary side and the secondary side of the transformer, respectively.

### DESCRIPTION OF THE PREFERRED EMBODIMENTS

Detailed illustrative embodiments of the present invention are disclosed herein. However, specific details disclosed herein are merely representative for purposes of describing exemplary embodiments of the present invention. This invention may, however, be embodied in many alternate forms and should not be construed as limited to the embodiments set forth herein.

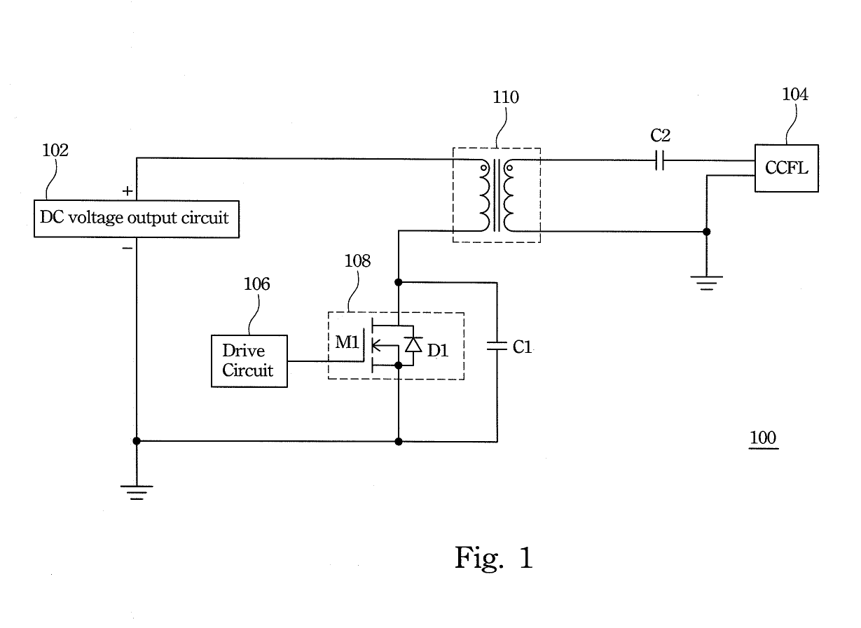

FIG. 1 shows a power supply circuit of a cold cathode fluorescent lamp (CCFL) according to one embodiment of the present invention. The power supply circuit 100 transforms a direct-current (DC) voltage, generated from a DC voltage output circuit 102, into an alternating-current (AC) voltage for the CCFL 104. The power supply circuit 100 includes a drive circuit 106, a switch 108, a transformer 110, a capacitor C1 and a decoupling capacitor C2. The switch 108 has a control terminal coupled to the drive circuit 106 and a ground terminal coupled to a ground. The drive circuit 106 outputs a pulse width modulation (PWM) signal to control the switch 108. The transformer 110 has a primary side and a secondary side. A winding on the primary side is coupled between the DC voltage output circuit 102 and a signal terminal of the switch 108 to generate the AC voltage on the secondary side. The capacitor 112 is coupled between the ground terminal and the signal terminal of the switch 108, and can further interact with the transformer 110 so as to determine the resonant frequency of the power supply circuit 100 and thus improve the efficiency of the power supply circuit 100. The decoupling capacitor C2 couples to one terminal of the secondary side of the transformer 110 and outputs the AC voltage for the CCFL 104. Further, the decoupling capacitor C2 and another terminal of the secondary side of the transformer 110 respectively couples to the CCFL 104.

The switch 108 can further include an n-type metal-oxide-semiconductor field effect transistor (MOSFET) M1 and a diode D1, in which the diode D1 can be a body diode of the transistor M1 or an additional diode connected in parallel with the transistor M1. A gate of the transistor M1, used as the control terminal of the switch 108, couples to the drive circuit 106. A first source/drain of the transistor M1, used as the signal terminal of the switch 108, couples to one terminal of the winding on the primary side of the transformer 110. A second source/drain of the transistor M1, used as the ground terminal of the switch 108, couples to the ground. Furthermore, the diode D1 is coupled between the first source/drain and the second source/drain of the transistor M1.

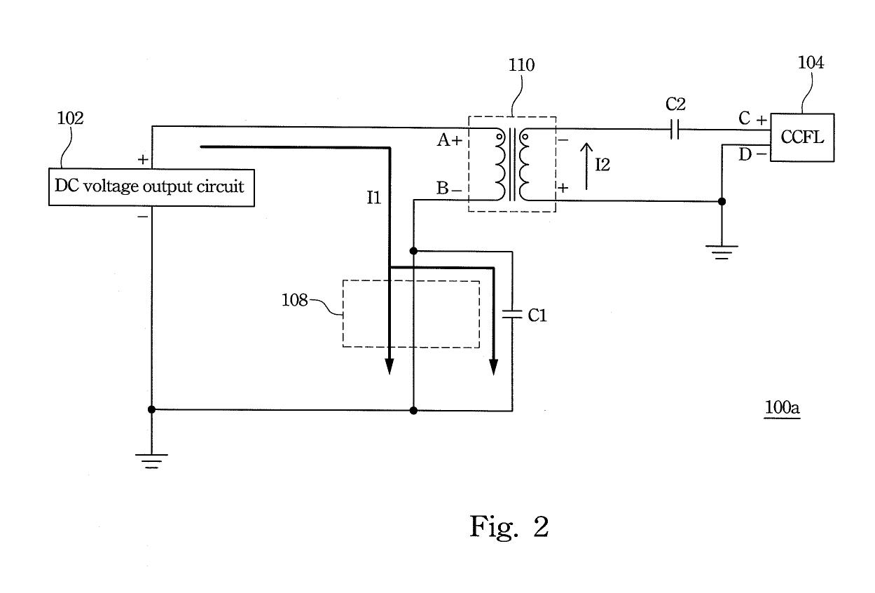

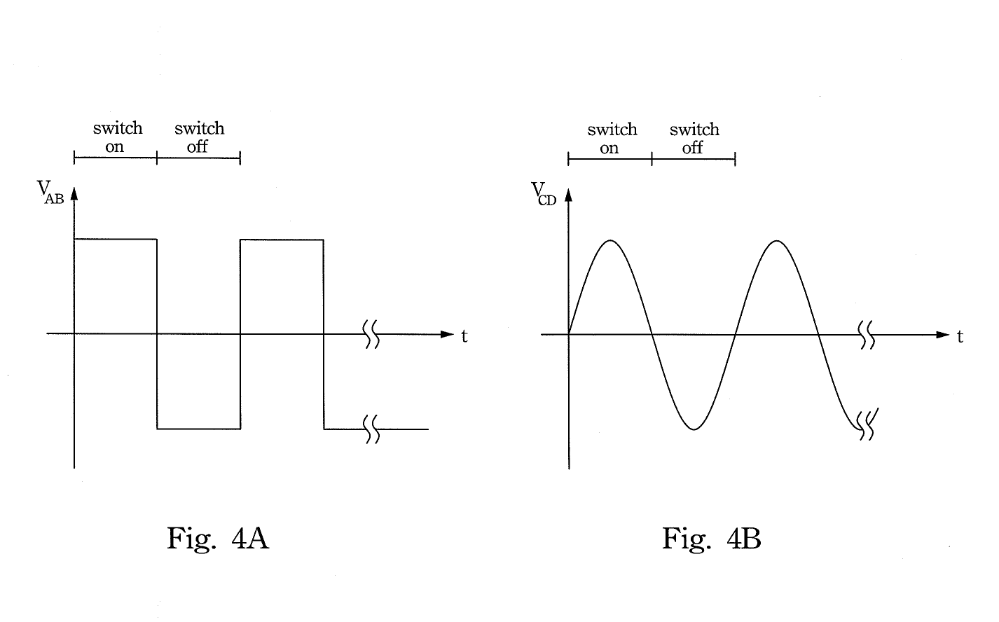

FIG. 2 shows the operation of the power supply circuit shown in FIG. 1 when the switch is turned on. FIG. 4A and FIG. 4B show the voltages on the primary side and the secondary side of the transformer, respectively. Referring to FIGS. 2, 4A and 4B, when the switch 108, i.e. the transistor M1, receives the signal from the drive circuit 106 and is thus turned on, the voltage outputted from the DC voltage output circuit 102 provides a positive voltage V_{A,B} for the primary side of the transformer 110. The current 11 therefore flows from the DC voltage output circuit 102 to the switch 108 through the transformer 110. The current 12 is also generated on the secondary side of the transformer 110, and flows through the decoupling capacitor C2. A voltage V_{C,D} for the CCFL 104 is accordingly generated. In addition, the current flows from the primary side of the transformer 110 to the capacitor C1, and the capacitor C1 is charged such that the voltage of the capacitor C1 increases with time.

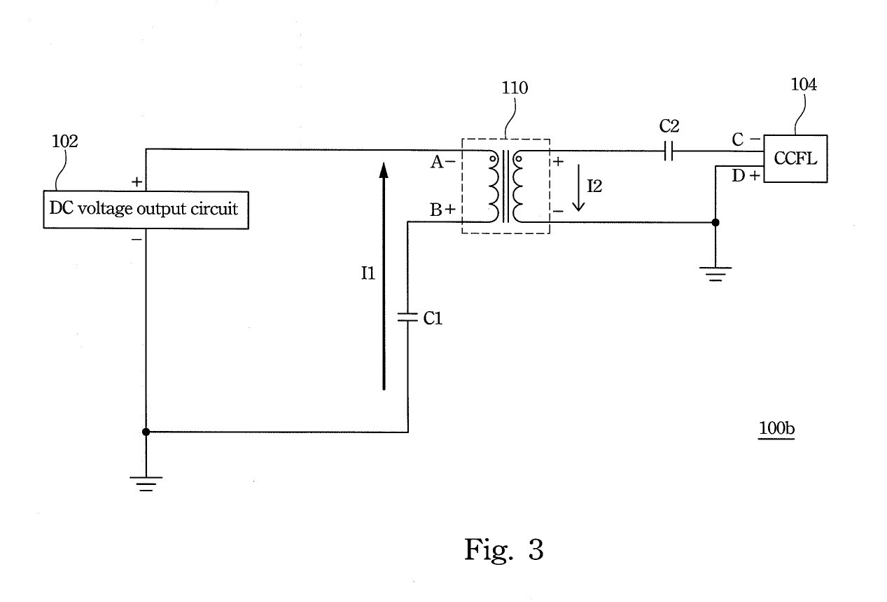

FIG. 3 shows the operation of the power supply circuit shown in FIG. 1 when the switch is turned off. Referring to FIGS. 3, 4A and 4B, when the switch 108, i.e. the transistor M1, receives the signal from the drive circuit 106 and is thus turned off, the capacitor C1 discharges and the primary side of the transformer 110 has a negative voltage V_{AB}. The current 11 then flows from the capacitor C1 to the primary side of the transformer 110. The current 12 is also generated on the secondary side of the transformer 110, and the voltage V_{C,D} for the CCFL 104 is accordingly generated. Therefore, the polarity of the voltage of the transformer 110 can be changed alternately, and the values and directions of the current 11 and 12, flowing through the primary side and secondary side of the transformer 110, respectively, can be changed accordingly with time.

According to the embodiments of the present invention, the power supply circuit has fewer transistors and is simpler than many known power supply circuits, so the production cost and production time can be reduced. In addition, the power supply circuit can only be controlled with a switch to transform the DC voltage into the AC voltage, so it is much easier to be controlled than usual and also more convenient to use for the cold cathode fluorescent lamp (CCFL).

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A power supply circuit for transforming a direct-current voltage into an alternating-current voltage for a light source, the power supply circuit comprising:
a drive circuit;
a switch having a control terminal coupled to the drive circuit and a ground terminal coupled to a ground;
a transformer having a primary side and a secondary side, wherein a winding on the primary side is coupled between the direct-current voltage and a signal terminal of the switch so that the alternating-current voltage is generated on the secondary side; and
a capacitor coupled between the ground terminal and the signal terminal of the switch.

2. The power supply circuit as claimed in claim 1, wherein the switch further comprises a diode coupled between the ground terminal and the signal terminal of the switch.

3. The power supply circuit as claimed in claim 2, wherein the diode is a body diode of the switch.

4. The power supply circuit as claimed in claim 1, wherein the drive circuit outputs a pulse width modulation signal to control the switch.

5. The power supply circuit as claimed in claim 1, further comprising:
a decoupling element coupled to a first terminal of the secondary side of the transformer and outputting the alternating-current voltage.

6. The power supply circuit as claimed in claim 5, wherein the decoupling element and a second terminal of the secondary side of the transformer respectively couples to the light source.

7. The power supply circuit as claimed in claim 1, wherein the switch comprises a metal-oxide-semiconductor field effect transistor.

8. The power supply circuit as claimed in claim 7, wherein the metal-oxide-silicon field effect transistor is an n-type metal-oxide-silicon field effect transistor.

9. The power supply circuit as claimed in claim 8, wherein the metal-oxide-silicon field effect transistor has a gate coupled to the drive circuit and a first source/drain coupled to a first terminal of the primary side of the transformer and a second source/drain coupled to the ground.
